(19) United States
(12) Patent Application Publication
(10) Pub. No.: US 2008/0210810 A1
(43) Pub. Date: Sep. 4, 2008

(54) AIRSHIP PORT OPERATIONS

(76) Inventor: Daniel W. Parmley, Phoenix, AZ (US)

Correspondence Address: KEITH L. JENKINS, 2222 NORTH MCQUEEN ROAD #2069, CHANDLER, AZ, 85225, US

(21) Appl. No.: 12/040,917

(22) Filed: Mar. 3, 2008

Related U.S. Application Data
(60) Provisional application No. 60/892,247, filed on Mar. 1, 2007.

(51) Int. Cl. B64B 1/06; B64B 1/70

(52) U.S. Cl. 244/30

(57) ABSTRACT

A process for conducting port operations with a cargo-lifting airship that enables inspection of cargo lifted from a cargo ship while the cargo-lifting airship is in route to a destination. If the cargo fails inspection, the cargo may be delivered to quarantine. If the cargo passes inspection, it may be delivered to its destination. The same embodiment may be used to load a container cargo ship with freshly inspected cargo containers and their cargo. Alternate embodiments are disclosed.

### RELATED APPLICATIONS

This application claims the benefit of U.S. provisional patent application 60/892,247 to the same inventor.

### FIELD OF THE INVENTION

The present invention relates to a process for using a lighter-than-air vehicle (hereinafter, “airship”) for unloading and/or loading cargo from cargo ships. The method further relates to conducting security and/or customs inspection of the cargo onboard the cargo-lifting airship while the cargo-lifting airship is in route to the cargo destination with the cargo.

### BACKGROUND OF THE INVENTION

Lighter-than-air aircraft include blimps, dirigibles, and balloons, all of which are varieties of aerostats. Blimps are aerodynamically shaped balloons with propulsion units and optionally with gondolas. The Goodyear blimp is a well-known example of a blimp. Dirigibles are rigid airships where the outer gas-containing envelope, or hull, has a rigid frame, and the lifting gas is contained in one or more gas bags therein. The Hindenberg is a well-known example of a dirigible. Blimps and dirigibles are referred to collectively as airships. Balloons typically do not have lateral propulsion systems, relying instead on lifting or descending into desirably-directed air currents. Hot air balloons are well known. Lighter-than-air aircraft obtain lift from buoyant forces exerted by the atmosphere on a hull substantially filled with a light-weight gas such as hydrogen or helium. Important economies are available from airships as compared to fixed-wing aircraft, which must burn fuel to generate lift.

There are various current airship designs, some of which reprise older designs with updated materials and technology and others generally based on hybrid designs using buoyant airfoils. The present inventor has patented a LIGHTER-THAN-AIR TWIN HULL HYBRID AIRSHIP disclosed in U.S. Pat. No. 6,843,448.

Port operations worldwide suffer from backlogs in getting cargo ships into proximity to the cranes used for off-loading cargo. The decks of modern cargo ships are often covered with cargo containers, such as ISO containers, which must be removed by a dockside crane. While cargo ships once had cranes on their decks, those are now removed to provide more room for cargo containers. As a result, modern container cargo ships cannot unload much of their own cargo. Instead, they rely on expensive fixed assets, such as portside cranes, to remove the cargo. The number of cranes at any port is limited, thereby creating a potential bottleneck in the cargo transportation system. Recently, 90 container cargo ships were observed off the port of Singapore, awaiting their turns to unload. This bottleneck represents millions of dollars per day in lost revenue. Reliance on portside cranes creates a vulnerability to various disruptions, such as labor strikes, natural disasters, and man-made disasters.

Another bottleneck in the system is created by the customs and security inspections required at ports. Eventually, each cargo container will have to be inspected at the port. The weakness of planned inspection systems is that, by the time you find out that the container has a weapon of mass destruction in it, the container is already in the port, and the weapon is at its target: the port.

In order to solve the above-mentioned problems, the inventor presents this novel and innovative invention.

### OBJECTS OF THE INVENTION

It is an object of this invention to decrease waiting time and unloading time for cargo ships at ports. It is a further object of this invention to save millions of dollars caused by delays in off-loading cargo at ports. It is a further object of this invention to provide a cargo-lifting airship for a transfer vehicle between the cargo ship and the shore. It is a further object of this invention to provide for inspection of cargo on board the cargo-lifting airship while the cargo-lifting airship is moving. It is a further object of this invention to provide a process for lifting cargo off of container ships at sea or in harbor. It is a further object of this invention to provide a process for lowering cargo onto container ships at sea or in harbor. It is a further object of this invention to provide a means of off-loading container ships when the desired port is unavailable. It is a further object of this invention to provide a process for delivering cargo to a quarantine area at a safe distance from the port. It is a further object of this invention to provide delivery of cargo to its destination. It is a further object of this invention to provide delivery of cargo to another cargo transport device. It is a further object of this invention to provide a method of conducting port operations in places where no port exists. It is a further object of this invention to provide recovery of cargo from the sea.

### BRIEF SUMMARY OF THE INVENTION

One embodiment of the invented method provides a cargo-lifting airship sized and arranged for lifting a cargo container off of a container cargo ship that is operated to secure the cargo container within the cargo-lifting airship and that enables inspection of the cargo while the cargo-lifting airship is in route to a destination. If the cargo fails inspection, the cargo is delivered to a quarantine destination. If the inspection result is that the cargo passes inspection, it may be delivered to its destination. The destination for passed cargo may be its ultimate destination or an intermediate destination, such as another transportation vehicle or depot. The same embodiment may be used to load a container cargo ship with freshly inspected cargo containers and their cargo. Another use for that embodiment provides a cargo-lifting airship sized and arranged to pick up spilled cargo containers out of the sea, operated for that purpose. In some cases, the first embodiment may be used for this purpose. Another embodiment may provide for other responses to cargo that has an inspection result indicating a failed inspection. For example, disarming contraband weapons, performing maintenance and repair on damaged containers, or performing repair of damaged cargo. While moving container cargo is the primary purpose of the first embodiment, adapters may be provided for moving other types of cargo.

### BRIEF DESCRIPTION OF THE DRAWINGS

The above and other objects and advantages of the present invention will become more apparent from the following description taken in conjunction with the following drawing in which:

FIG. 1 is a block diagram illustrating an exemplary embodiment of the process of airship port operations, according to a preferred embodiment of the present invention;

FIG. 2 is a diagrammatic view of a first exemplary embodiment of a cargo-lifting airship used in the exemplary process of airship port operations, according to a preferred embodiment of the present invention;

FIG. 3 is a front diagrammatic view of a second exemplary embodiment of a cargo-lifting airship used in the exemplary process of airship port operations, according to a preferred embodiment of the present invention; and

FIG. 4 is a side diagrammatic view of the second exemplary embodiment of a cargo-lifting airship of FIG. 3 used in the exemplary process of airship port operations, according to a preferred embodiment of the present invention.

### DETAILED DESCRIPTION OF THE DRAWINGS

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

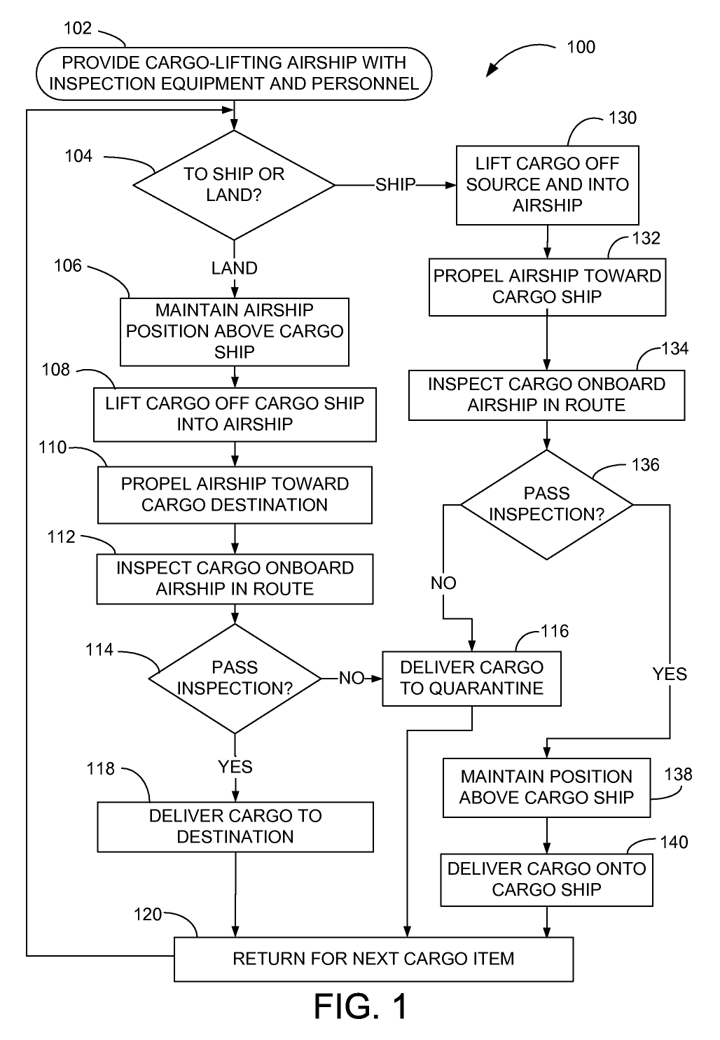

FIG. 1 is a block diagram illustrating an exemplary embodiment of the process of airship port operations 100, according to a preferred embodiment of the present invention. The objective of airship port operations is to move cargo from one side of an inspection boundary to a second side of an inspection boundary, realizing that less than all cargo that is picked up should reach the second side of the inspection boundary. The inspection boundary may be an international border.

One exemplary embodiment of the process 100 is shown as beginning with step 102. Step 102 provides a cargo-lifting airship with inspection equipment and personnel. The cargo-lifting airship of step 102 is preferably a variant of twin-hull cargo-lifting airship as shown in FIG. 13 of U.S. Pat. No. 6,843,448. The cargo-lifting airship has a cargo bay and is outfitted with appropriate inspection equipment, such as electronic sensors, (i.e., scanners, chemical sniffers), communications gear, and the like, to enable the inspection teams to perform their various functions. Space is provided in the cargo-lifting airship and proximate the cargo bay for inspection personnel. Normally, more than one cargo-lifting airship will be provided per cargo ship. That is, a number of cargo-lifting airships, in various stages of the process 100, will be operating simultaneously on the cargo of one cargo ship.

In step 104, a decision is made as to whether the present task is a loading or unloading mission. If the purpose is unloading, step 108 begins the loading process. The cargo-lifting airship is brought into a position above the cargo ship, preferably within less than 200 feet of the highest point on the cargo ship, and maintains that relative position. If the cargo ship is stationary, the cargo-lifting airship may hover above the cargo ship under manual, autonomous, or remote control. If the cargo ship is underway, the cargo-lifting airship will match velocity with the cargo ship in a position above the cargo ship under manual, autonomous, or remote control. If the cargo to be lifted requires a special lifting adapter, that adapter is selected and installed, preferably on the way to the ship to be unloaded. In some cases, it may be necessary to install the cargo lift adapter prior to the cargo-lifting airship leaving to go to the cargo ship. Adapters may include cable spreaders, lifting frames, pallets, and combinations of such devices as are known in the art. For bulk cargo, a scoop, tank, or container may serve as the cargo adapter.

In step 108, the cables for lifting the cargo, and the cargo lift adapter, if any, are lowered towards the cargo to be lifted. Workers on the cargo ship attach the cables to the cargo according to a prearranged plan, and the cargo-lifting airship reels in the cables to lift the cargo off the cargo ship and into the cargo bay of the cargo-lifting airship. In some embodiments, workers from the cargo-lifting airship may be lowered with the cables, in order to attach the cables to the cargo. Once the cargo is lifted into place in the cargo bay, the cargo is secured to improve the safety of the inspection teams in step 112. In cases where a particular cargo ship may be delivering some containers to a first port and other containers to a second port, a fleet of cargo-lifting airships may be provided to remove the containers for the first port while the cargo ship is at sea, thereby obviating the need for one port call.

In step 110, the cargo-lifting airship is propelled, by its own propulsion system, toward the destination for the cargo. This destination may be the final destination for the cargo, such as a distributor's warehouse, where the cargo may be lowered for delivery. Alternatively, the destination may be an intermediate transportation vehicle, such as a truck, railroad car, smaller ship, barge, other cargo ship, or the like. In cases of high-risk cargo, the original destination may be a quarantine area, with quarantine avoided only if the cargo is found to contain no contraband. Preferably, the cargo is placed as close to the coast as possible, to allow the cargo-lifting airship to return to unloading duties as soon as possible. In countries with good highway infrastructure and good railway infrastructure, it may be more economical to use surface transportation. In countries without a good transportation infrastructure, the cargo-lifting airship may take the cargo to its final destination.

In step 112, the cargo is inspected on board the cargo-lifting airship while it is in route to its destination and the inspection produces an inspection result. The inspection of step 112 may be a customs inspection. The inspection of step 112 may be a security inspection. The inspection of step 112 may be an immigration and naturalization service inspection. In some alternate embodiments, multiple types of inspections may take place. Inspection devices, such as the electronic sensors of the type now coming into use at US ports, may be installed in the cargo-lifting airship cargo bay to expedite inspection. The cargo bay is preferably sized to allow room for the cargo and for inspectors to work.

The time available for inspection may vary significantly, depending on the distance between the cargo ship and the cargo destination and the speed of the cargo-lifting airship in the extant weather. In some cases, high-risk cargo may be picked up more than 100 miles off shore, allowing extensive time for inspection, but tying up a lot of human resources for the trip. In other cases, the cargo ship may be in the harbor, but in a long line to get to the port facilities, in which case, the flight time to the cargo destination may be brief. In some such cases, the cargo-lifting airship may hover until the inspection is completed. In other such cases, it may be more economical to land the cargo to complete one or more of the inspections at the port facilities. Electronic sensing of the cargo may expedite the inspection.

In step 114, a determination is made as to whether or not the cargo passes inspection, i.e. an inspection result is obtained. If the cargo does not pass inspection in step 114, it may be delivered to quarantine in step 116. The quarantine may be a place on shore or at sea. For example, the Department of Homeland Security may maintain a quarantine cargo ship at sea, a safe distance from the shore, to receive especially dangerous contraband. Different departments of the Government may have separate quarantine areas. For example, INS may have one area, perhaps off shore, for illegal immigrants, while customs agents may have a quarantine area on shore for infringing goods. The contraband may be directed to any one of various quarantines, depending on the nature and priority of the contraband.

If the cargo passes inspection in step 114, (a positive inspection result) it will be delivered to its destination. This destination may be the final destination for the cargo, such as a distributor's warehouse, where the cargo may be lowered for delivery. Alternatively, the destination may be an intermediate transportation vehicle, such as a truck, railroad car, smaller ship, barge, other cargo ship, or the like. Preferably, the destination will be close to shore. However, in particular cases, the delivery may be made far inland. For example, a delivery of strategic metals from a foreign source may be more secure going directly to its final destination than being transferred to another vehicle. For a further example, a container of relief supplies for a disaster area may be delivered far inland where the roads have been destroyed, as in the recent Pakistani earthquake.

After delivery, the cargo-lifting airship returns to duty in step 120. If the next task is determined, in step 104, to be a loading operation, then the cargo-lifting airship picks up its cargo in step 130 before leaving the shore. Various sources of cargo are included within step 130. For example, the cargo may picked up from a train (preferably stopped), a truck (preferably parked), a barge, a smaller ship, other cargo ship, or the like, by lowering the cables, attaching the cables to the cargo container, and then raising the cargo into the cargo bay of the cargo-lifting airship. Likewise, the cargo may be picked up off the dock by the same process. In some alternate embodiments, the cargo may be picked up at the manufacturer's plant and taken to the cargo ship.

Once the cargo is on board in step 130, the cargo-lifting airship is propelled toward the cargo ship in step 132. The route may not be direct, as inspectors will be required in a future step 134. In some embodiments, the inspectors may be part of the aircrew. In other embodiments, the inspectors may be passengers picked up along the way to the cargo ship in step 132.

The cargo may be inspected in the same manner as incoming cargo or other standards may be applied in step 134. If the inspection result indicates that the cargo is determined to have failed inspection in step 136, it may be delivered to quarantine in step 116, as described above. If the outbound cargo passes inspection, the cargo-lifting airship moves into delivery position above the cargo ship in step 138. While closely coordinating with the cargo ship's crew, the cargo is lowered onto the cargo ship and secured there by the cargo ship's crew.

After delivery, the cargo-lifting airship returns to duty for the next task in step 120.

Those of skill in the art, informed by the present disclosure, will appreciate that the process 100 enables port operations where no port exists. For example, if Pacific Coast American ports were unavailable, cargo could be received along the Pacific Coast by process 100 delivering cargo onto flatbed railroad cars on rails in the coastal states, onto trucks on local highways, or to the final cargo destination, such as a grocery store or refugee center. For further example, in the case of a hurricane in an urban area along the Gulf Coast, emergency supplies could be delivered directly to refugee centers or to neighborhoods. In an alternate embodiment, the cargo may be a modular hospital built into one or more ISO containers, a fresh water supply, food, water purification equipment, generators, and the like. In another alternate embodiment, the cargo-lifting airship may carry a full fuel bladder as cargo on the way to the cargo ship, at least partially refuel the cargo ship, and then bring cargo back on the return flight. In still another alternate embodiment, a group of cargo-lifting airships may support sections of a portable pipeline between ship and shore for loading or unloading liquid cargo.

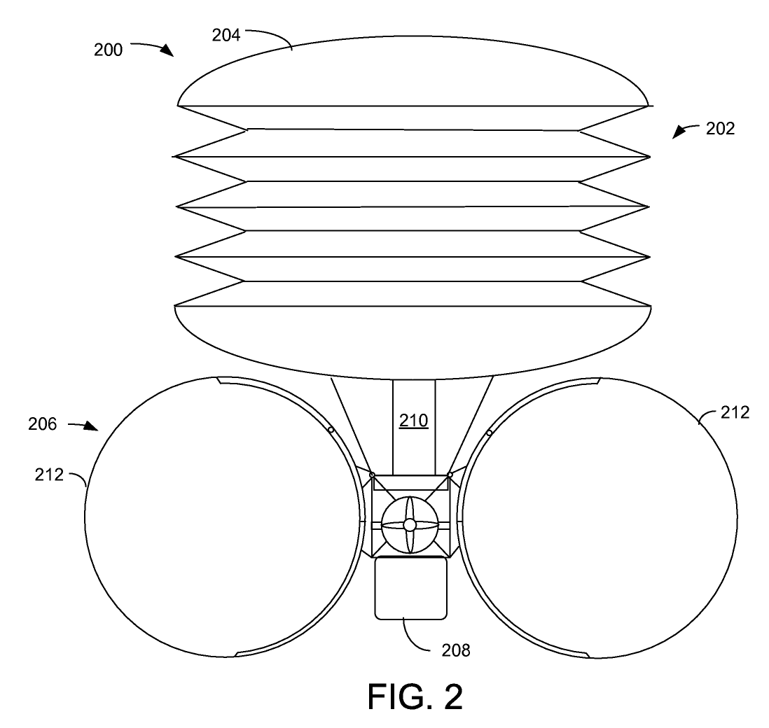

FIG. 2 is a diagrammatic view of a first exemplary embodiment of a cargo-lifting airship 200 used in the exemplary process 100 of airship port operations, according to a preferred embodiment of the present invention. The first embodiment of the cargo-lifting airship 200 preferably has two portions 202 and 206. The first portion 202 of two portions 202 and 206 includes the cargo bay 208 and related equipment, as well as at least one expandable cargo hull 204 (preferably, at least two), and mechanisms 210 for expanding and contracting the at least one cargo hull 204. The at least one cargo hull 204 may be contracted to minimize lift when no cargo is loaded, and expanded to lift the cargo when cargo is loaded, thus solving the ballasting problem that challenges other cargo-lifting airships. The mechanisms for contracting and expanding the cargo hull 204 may include, without limitation, pumps and pressure vessels for pumping gas from the at least one cargo hull to the pressure vessels and clam-shell cargo hull portions which may be urged together to minimize the displacement of the at least one cargo hull 204 and/or to pressurize the gas within the cargo hull 204. The second portion 206 of two portions 202 and 206 of the cargo-lifting airship 200 comprises at least one flight hull 212 sized, shaped, and arranged to lift the first portion 202 when the first portion 202 has no cargo and the at least one cargo hull 204 is contracted. Because the at least one cargo hull 204 will expand to lift cargo of various weights, the second portion 206 can lift the first portion 206 under any cargo load conditions within design limits.

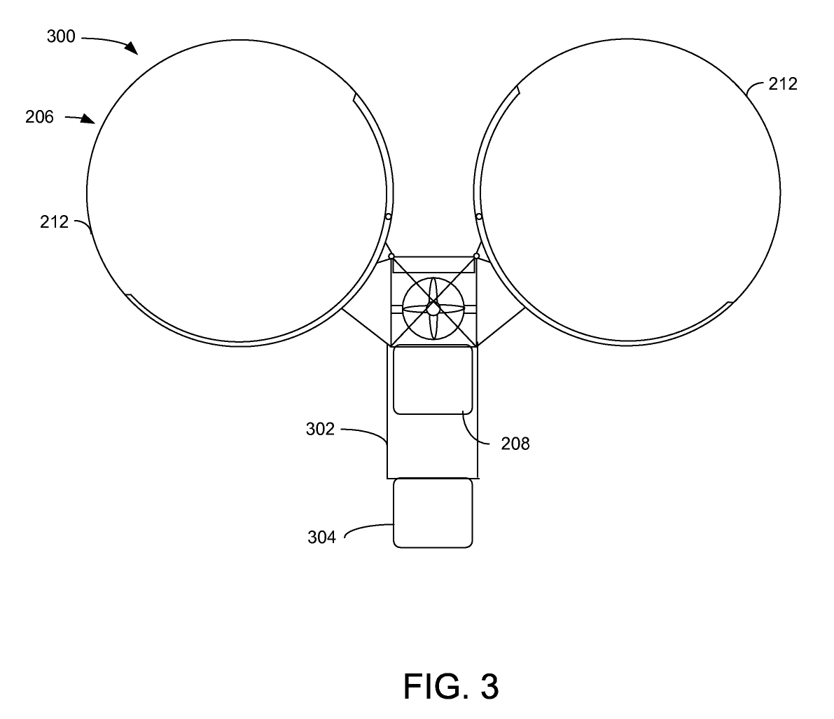

FIG. 3 is a front diagrammatic view of a second exemplary embodiment of a cargo-lifting airship 300 used in the exemplary process of airship port operations 100, according to a preferred embodiment of the present invention. The second embodiment of the cargo-lifting airship 300 is designed for neutral buoyancy with cargo loaded without the use of expanding and contracting cargo hulls 204. The cargo-lifting airship 300 is coupled to at least one container 304 for taking on water, including seawater, having a weight up to the maximum cargo weight for the particular design. When the cargo-lifting airship 300 lands to deliver cargo, the cargo-lifting airship takes on water, achieving temporary negative buoyancy, and then releases the cargo, thereby achieving neutral buoyancy again. When the cargo-lifting airship lands to pickup cargo, it achieves temporary negative buoyancy from taking on the cargo, and then discharges the water to achieve neutral buoyancy for flight. Preferably, the water ballast container 304 may act as a scoop to take on water near the dock where the cargo is to be delivered, thereby obviating the need for a pump. Likewise, release valves in the water ballast container 304 may obviate the need for pumps when discharging the water. Water ballast container 304 may be suspended by cables 302 and withdrawn upward, when empty, into the frame of the cargo-lifting airship 300. In a particular embodiment, the water ballast container 304 may be made of heavy fabric.

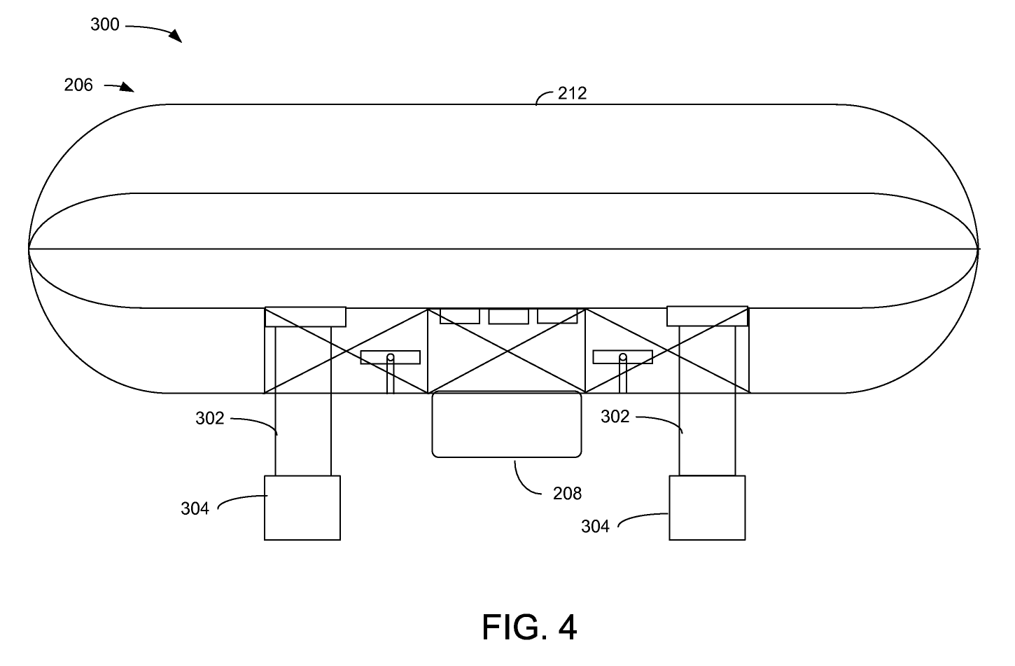

FIG. 4 is a side diagrammatic view of the second exemplary embodiment of a cargo-lifting airship 300 of FIG. 3 used in the exemplary process of airship port operations 100, according to a preferred embodiment of the present invention. The side diagrammatic view aids in understanding that the cargo-lifting airship 300 may pick up or deliver cargo while straddling a pier or ship. With the cargo-lifting airship 300 straddling the pier or ship cross-wise, the water ballast containers 304 may be lowered before cargo is released to fill the water ballast containers 304 with water and preserve neutral buoyancy after the cargo is released. Likewise, water ballast containers 304 may be emptied when cargo is picked up. The cargo picked up from a pier may be directly picked up from a land vehicle, such as a truck or a train, on the pier.

While at least one exemplary embodiment has been presented in the foregoing detailed description, it should be appreciated that a vast number of variations exist. While the primary (and highly economical) purpose of the cargo-lifting airship is port operations 100, those of skill in the art, enlightened by this disclosure, will appreciate the alternate operations that can be conducted with such an cargo-lifting airship with no or minor variations in the cargo-lifting airship. For example, the cargo lifted by the cargo-lifting airship could be an operational payload for communications, surveillance, command and control, monitoring, or any other operation that can be conducted from an airborne platform with affordable operating costs and indefinitely long airborne loiter time. For further example, the cargo container could be an air ambulance module for evacuating multiple casualties from a disaster area at a time. For further example, the cargo may be a land vehicle or marine vehicle, such as an entire truck or a boat that is to be moved to a new location for prompt operation there. For further example, the cargo may be a disabled vehicle that needs to be removed for maintenance and repair. In one alternate embodiment, a new vehicle may be delivered to replace a disabled one, and the disabled one may then be retrieved using the same cargo adapter. In another alternate embodiment, the cargo may be a modular repair shop for field equipment of any kind. In yet another alternate embodiment, the cargo may be a small manufacturing plant for manufacturing goods from raw materials picked up from cargo ships. While it may not be economical to provide cargo-lifting airships solely for the alternative processes just described, once the cargo-lifting airships are built for port operations 100, they may be pressed into alternative service in an emergency. Those desiring alternative processes need only construct the appropriate “cargo” and possibly a cargo adapter for the mission. In yet another alternate embodiment, the cargo adapter may be a truss for coupling two or more cargo-lifting airships together for lifting exceptionally heavy cargo. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A process for using a cargo-lifting airship for moving cargo across a legally established inspection boundary, such boundary having a first side and a second side, the process comprising the steps of:
a. providing a cargo-lifting airship;
b. loading such cargo onboard said cargo-lifting airship on such first side of such inspection boundary; and
c. inspecting such cargo onboard said cargo-lifting airship.

2. The process of claim 1, further comprising the steps of:
a. obtaining an inspection result from the step of inspecting such cargo onboard said cargo-lifting airship; and
b. determining a destination for such cargo based at least partially on said inspection result.

3. The process of claim 2, wherein said destination is quarantine.

4. The process of claim 2, wherein said destination is on a second side of such inspection boundary.

5. The process of claim 4, wherein said destination is a final destination of such cargo.

6. The process of claim 1, wherein the step of providing a cargo-lifting airship comprises the step of providing a providing a cargo-lifting airship comprising at least one cargo hull.

7. The process of claim 1, wherein the step of providing a cargo-lifting airship comprises the step of providing a providing a cargo-lifting airship comprising at least one water ballast container.

8. The process of claim 1, wherein the step of loading such cargo onboard said cargo-lifting airship comprises the step of loading such cargo from a ship.

9. The process of claim 1, wherein the step of loading such cargo onboard said cargo-lifting airship comprises the step of loading such cargo from a land vehicle.

10. The process of claim 1, wherein the step of inspecting such cargo onboard said cargo-lifting airship comprises the step of electronic sensing.

11. A process for using a cargo-lifting airship for moving cargo across a legally established inspection boundary, such boundary having a first side and a second side, the process comprising the combination of the steps of:
a. providing a cargo-lifting airship;
b. loading such cargo onboard said cargo-lifting airship on such first side of such inspection boundary;
c. inspecting such cargo onboard said cargo-lifting airship;
d. obtaining an inspection result from the step of inspecting such cargo onboard said cargo-lifting airship;
e. determining a destination for such cargo based at least partially on said inspection result; and
f. delivering such cargo to said destination on such second side of such destination boundary.

12. The process of claim 11, further comprising the steps of:
a. loading another such cargo onboard said cargo-lifting airship on such second side of such inspection boundary;
b. inspecting such cargo onboard said cargo-lifting airship;
c. obtaining an inspection result from the step of inspecting such cargo onboard said cargo-lifting airship;
d. determining a destination for such cargo based at least partially on said inspection result; and
e. delivering such cargo to said destination on such first side of such destination boundary.

13. The process of claim 11, further comprising the steps of:
a. loading another such cargo onboard said cargo-lifting airship on such second side of such inspection boundary;
b. inspecting such cargo onboard said cargo-lifting airship;
c. obtaining an inspection result from the step of inspecting such cargo onboard said cargo-lifting airship;
d. determining a destination for such cargo based at least partially on said inspection result; and
e. delivering such cargo to said destination on such second side of such destination boundary.

14. The process of claim 11, wherein the step of providing a cargo-lifting airship comprises the step of providing a providing a cargo-lifting airship comprising at least one cargo hull.

15. The process of claim 11, wherein the step of providing a cargo-lifting airship comprises the step of providing a providing a cargo-lifting airship comprising at least one water ballast container.

16. The process of claim 11, wherein the step of loading such cargo onboard said cargo-lifting airship comprises the step of loading such cargo from a ship.

17. The process of claim 11, wherein the step of loading such cargo onboard said cargo-lifting airship comprises the step of loading such cargo from a land vehicle.

18. A process for using a cargo-lifting airship for moving cargo across a legally established inspection boundary, such boundary having a first side and a second side, the process comprising the combination of the steps of:
a. providing a cargo-lifting airship;
b. loading such cargo onboard said cargo-lifting airship on such first side of such inspection boundary;
c. inspecting such cargo onboard said cargo-lifting airship;
d. obtaining an inspection result from the step of inspecting such cargo onboard said cargo-lifting airship;
e. determining a destination for such cargo based at least partially on said inspection result; and
f. delivering such cargo to said destination on such second side of such destination boundary;
g. loading another such cargo onboard said cargo-lifting airship on such second side of such inspection boundary;
h. inspecting such other cargo onboard said cargo-lifting airship;
i. obtaining an inspection result from the step of inspecting such other cargo onboard said cargo-lifting airship;
j. determining a destination for such other cargo based at least partially on said inspection result; and
k. delivering such cargo to said destination on such first side of such destination boundary.

19. The process of claim 18, wherein the step of providing a cargo-lifting airship comprises the step of providing a providing a cargo-lifting airship comprising at least one cargo hull.

20. The process of claim 18, wherein the step of providing a cargo-lifting airship comprises the step of providing a providing a cargo-lifting airship comprising a water ballast container.
